(19) United States
(12) Patent Application Publication
(10) Pub. No.: US 2017/0169350 A1
(43) Pub. Date: Jun. 15, 2017

(54) METHOD FOR MEASURING USER BEHAVIOR CONSISTENCY DEGREE BASED ON COMPLEX CORRESPONDENCE SYSTEM

(71) Applicant: TONGJI UNIVERSITY, SHANGHAI (CN)

(72) Inventors: CHANGJUN JIANG, SHANGHAI (CN); HONGZHONG CHEN, SHANGHAI (CN); CHUNGANG YAN, SHANGHAI (CN); ZHIJUN DING, SHANGHAI (CN); MIMI WANG, SHANGHAI (CN); PEIHAI ZHAO, SHANGHAI (CN)

(73) Assignee: TONGJI UNIVERSITY, SHANGHAI (CN)

(21) Appl. No.: 15/325,184

(22) PCT Filed: Dec. 31, 2014
(86) PCT No.: PCT/CN2014/095859

§ 371 Date: Jan. 10, 2017

(30) Foreign Application Priority Data
Jul. 10, 2014 (CN) 201410327709.2

(51) Int. Cl. G06N 5/04; G06N 7/00; G06N 99/00; G06F 17/30; G06F 17/16

(52) U.S. Cl. CPC G06N 5/048; G06F 17/30598; G06F 17/30604; G06F 17/16; G06N 99/005; G06N 7/00

(57) ABSTRACT

A method for measuring user behavior consistency degree based on a complex correspondence system, which is applied to internet payment platform security. An entire solution is divided into three stages: at a first stage, analyzing complex correspondence relation characteristics according to an existing user behavior model; at a second stage, establishing a behavior profile according to user behavior characteristics and establishing user behavior relation matrixes; and at a third stage, completing user behavior matrix decomposition according to the complex correspondence characteristics of a user, calculating a user behavior consistency degree and detecting a degree of consistency between user behaviors and expected behaviors. The internal behavior relation of the user is more elaborately analyzed, the user behavior relation profile is established, the complex correspondence relations are distinguished and classified, and user behavior consistency measurement and analysis architecture based on the complex correspondence relations are given.

### FIELD OF INVENTION

The present invention relates to a measurement for user behavior consistency degree, which can be applied to internet payment platform security.

### DESCRIPTION OF RELATED ARTS

With the rapid development of computers, the application of online payment platforms increasingly becomes wider, and the requirements on detection technologies of the behavior consistency in payment processes of users also increasingly become stricter.

Since system designers and modelers hold different points of view on the same real world phenomenon, different models are established consequently. Consistency of models is related to matching semantics of models elements under model matching situations. As a result, complex correspondence situations exist self-evidently. According to statistics, for correspondence existing in process models, more than 40% is complex correspondence and more than 7% is cross repetitive correspondence. How to perform consistency analysis to user behaviors and expected behaviors in electronic transaction processes obviously has a critical significance to models existing complex systems.

In the past, some researches were carried out to consistency between two models (i.e., a user behavior measurement model and an expected model), and measurement methods such as trace matching, mutual simulation and behavior profiling were put forward (see notes [1-5] below). However, these methods cannot effectively distinguish situations of complex correspondence between behaviors in the aspect of complex correspondence, such that the calculation accuracy is greatly discounted.

The following indexes are provided, and open literatures corresponding to the indexes are close or related arts of the technical solution of the present invention and are viewed as part of the description of the present invention. Therefore, for technical terms which are involved in the technical solution of the present invention and prior arts on which the implementation of the technical solution depends, a reference can be made to the following information:

[1] Matthias Weidlich, Jan Mendling, Mathias Weske. Efficient consistency measurement based on behavioral profiles of process models [J]. IEEE Transactions on Software Engineering, 2001, 37(3): 410-129.

[2] MatthiasWeidlic, Behavioral profiles -a relational approach tobehavior consistency [DB/OL]. Institutional Repository of the University of Potsdam: URLhttp://opus.kobv.de/ubp/volltexte/2011/5559/URN urn:nbn:de:kobv:517-opus-55590, 2011.

[3]Sergey Smirnov, Matthias Weidlich, Jan Mendling. Business Process Model Abstraction Based on Behavioral Profiles [C]. Heidelberg: SpringerVerlag, 2010: 1-16.

[4] MatthiasWeidlich, Mathias Weske, Jan Mendling. Change Propagation in Process Models Using Behavioral Profiles[C]. Washington: IEEE Computer Society Washington, 2009: 33-40.

[5] Matthias Weidlich, Jan Mendling. Perceived consistency between process models[J]. Information Systems, 2012, 37(2): 80-98.

[6] ZHEHUI WU, introductory theory of Petri net [M], Chinese Mechanical industry press, 2006.

### SUMMARY OF THE PRESENT INVENTION

The purpose of the present invention is to overcome the defects of the prior art, so as to measure behavior consistency between a user behavior model and an expected model, perform specific classified analysis to complex correspondence behavior relations and determine behavior correspondence characteristics of all complex classes; and solve the problem of measurement of behavior consistency containing cross repetitive correspondence, calculate behavior consistency of models by using knowledge related to matrixes and measure a compliance degree of behavior consistency containing complex correspondence relations.

For this purpose, the following technical solution is adopted:

A method for measuring user behavior consistency degree based on a complex correspondence system is characterized in that an entire solution is divided into three stages:

a first stage comprising the following specific implementation steps:

step 1-1: subdividing cross order relations based on an existing workflow net, and refining behavior profile relations;

step 1-2: analyzing complex correspondence relations, classifying the complex correspondence relations and determining behavior characteristics of each class; and

step 1-3: simultaneously analyzing transitive dependency relations between user activities according to indirect relations between users,

wherein steps 1-1, 1-2 and 1-3 are performed in parallel;

a second stage comprising the following specific implementation steps:

step 2-1: determining correlations between five classes of correspondence relations according to the classification of the complex correspondence relations completed in step 1-2 and the behavior characteristics of each class;

step 2-2: establishing user extended behavior profile relations according to the behavior profile relations refined in step 1-1;

step 2-3: converting user behavior relations into matrix elements based on step 2-2 in combination with step 1-3 according to a formula

$${a}_{ij} = \{ \begin{matrix}2 & \text{?} + {a}_{j} \\ 1 & \text{?} {a}_{j} \\ {0}_{0} & \text{?} \\ {0}_{1} & \text{?} \\ {0}_{2} & \text{?} \\ {0}_{3} & \text{?} \\ - 1 & \text{?}\end{matrix} ( i , j = 1 , 2 , … , n ) \\ \text{?} \text{indicates text missing or illegible when filed}$$

(wherein aᵢⱼ denotes elements in behavior relation matrix); and

step 2-4: establishing a user behavior relation matrix graph based on steps 2-2 and 2-3,

wherein an establishment step thereof is as follow from matrix MD₁→MD₂→MD₃→MD₄ . . . →MDₙ→MD):

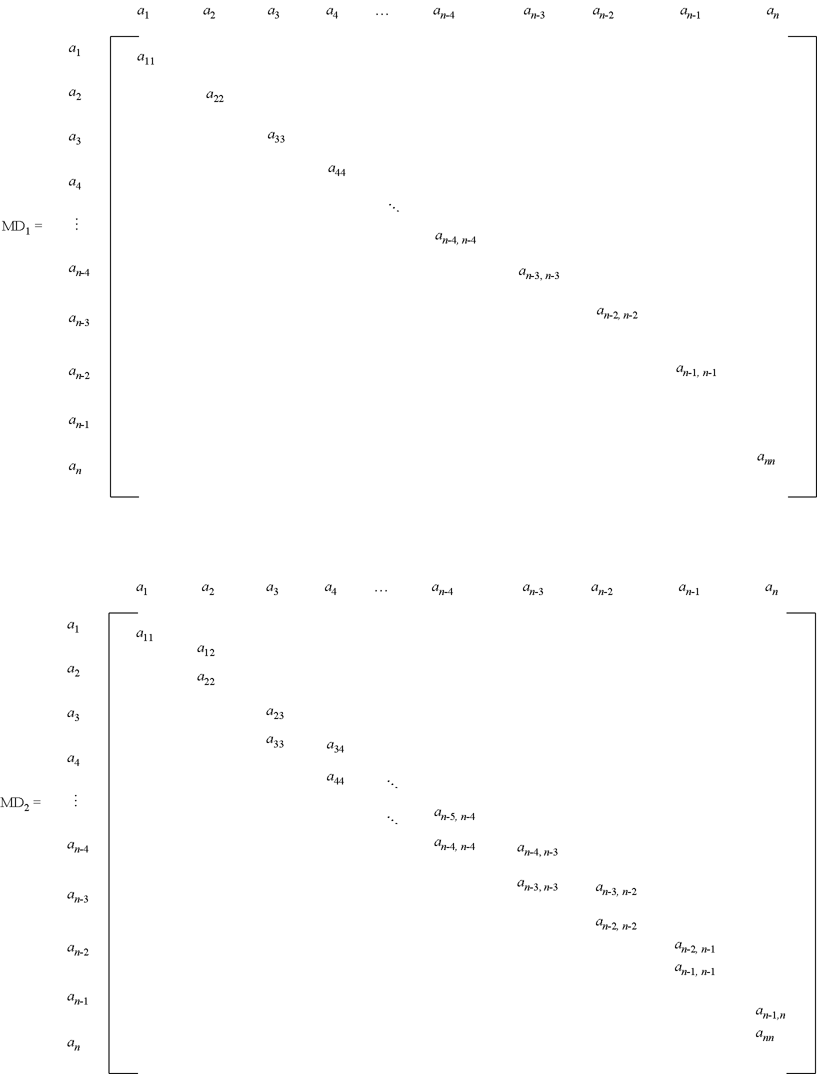

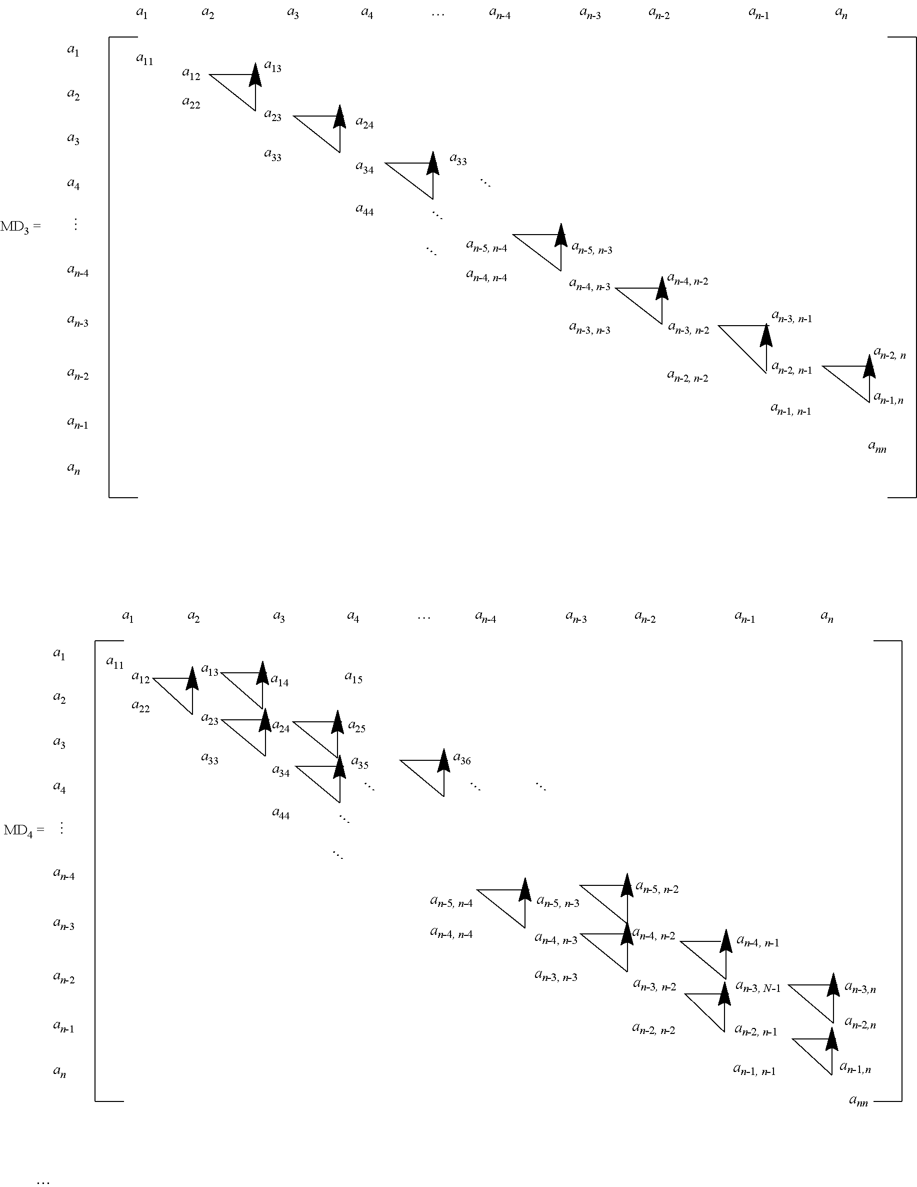

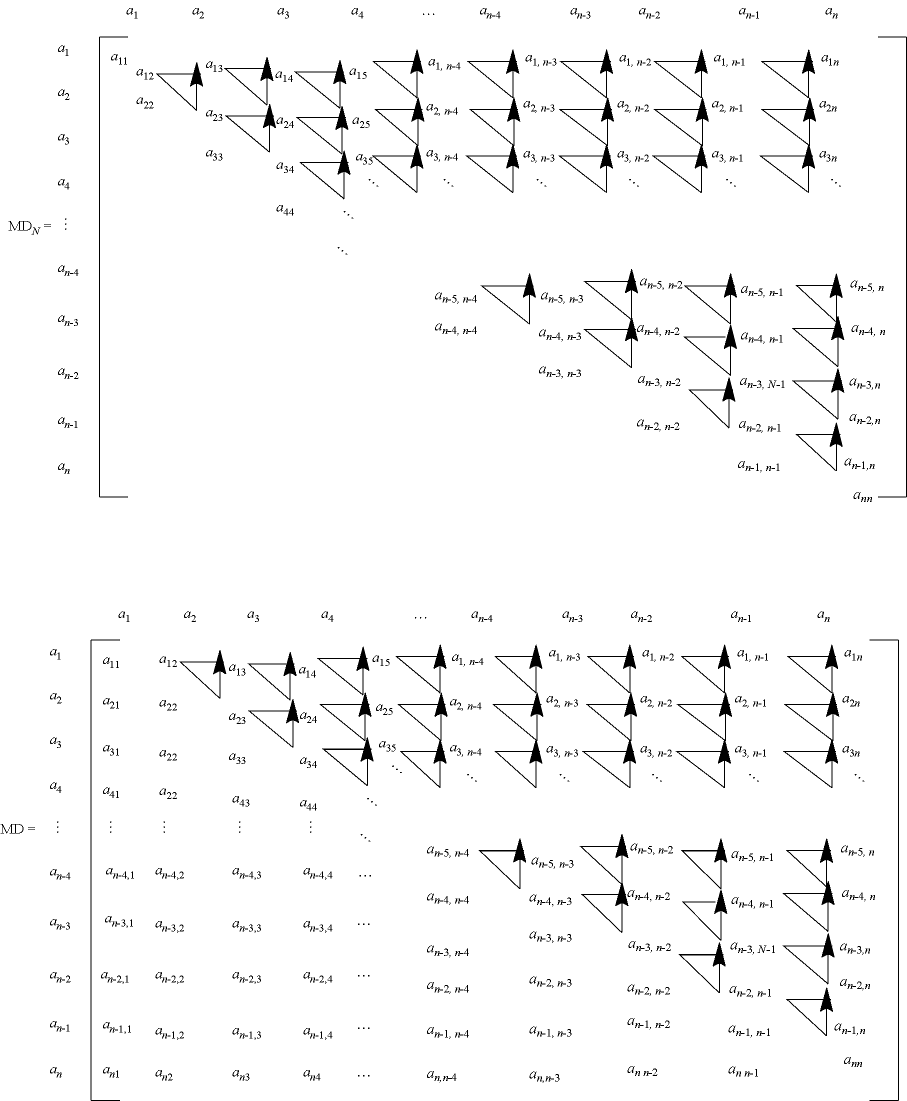

a third stage comprising the following specific implementation steps:

step 3-1: decomposing the user behavior relation matrixes according to the five user complex correspondence relation classes determined in step 2-1 and the behavior relation matrix graph established in step 2-4; and

step 3-2: calculating behavior consistency between a user model and an expected model according to correspondence relations between an actual model and the expected model of a user,

calculation formula:

$$consistency degree = \frac{area of consistent behavior relation matrixes}{total area of behavior relation matrixes}$$

wherein consistent behavior relations show consistent portions of user activities, area of behavior matrixes is used for depicting entire consistent behavior relations thereof, a higher consistency value represents that user behaviors and expected behaviors are more consistent, a lower consistency value represents that the user behavior and the expected behaviors are more inconsistent, and when consistency is particularly low, the user behaviors are suspected as illegal behaviors.

### BRIEF DESCRIPTION OF THE DRAWINGS

FIG. 1 is a system architecture diagram.

FIG. 2 is a business process Petri net diagram.

FIG. 3 is a behavior relation graph of FIG. 2.

FIG. 4 is a decomposition graph of FIG. 3.

FIG. 5 is a flowchart of algorithm 1.

FIG. 6 is a flowchart of algorithm 2.

### DETAILED DESCRIPTION OF THE PREFERRED EMBODIMENTS

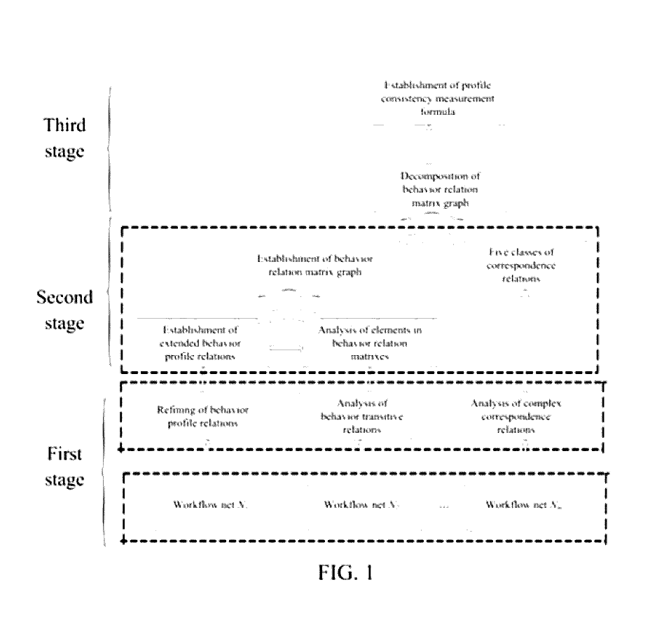

More delicate analysis is performed on internal behavior relations of a user, profiles of user behavior relations are established, complex correspondence relations are distinguished and classified, and user behavior consistency measurement and analysis architecture based on the complex correspondence relations is given, as shown in FIG. 1. This architecture can effectively distinguish the complex correspondence relations and accordingly make a more accurate judgment to behavior correspondence relations. The complex correspondence relations are effectively distinguished and calculated, the problem of behavior consistency measurement of complex correspondence model pairs is solved and the operation time is greatly shortened.

As shown in FIG. 1 which illustrates a system structural diagram of a method for measuring a user behavior consistency degree, an entire solution is divided into three stages: at a first stage, analyzing complex correspondence relation characteristics according to a traditional user behavior model, at a second stage, establishing a behavior profile according to user behavior characteristics and establishing user behavior relation matrixes, and at a third stage, completing user behavior matrix decomposition according to the complex correspondence characteristics of a user, calculating a user behavior consistency degree and detecting a degree of consistency between user behaviors and expected behaviors.

The first stage comprises the following specific implementation steps:

step 1-1: subdividing cross order relations based on an existing workflow net, and refining behavior profile relations;

step 1-2: analyzing complex correspondence relations, classifying the complex correspondence relations and determining behavior characteristics of each class; and step 1-3: simultaneously analyzing transitive dependency relations between user activities according to indirect relations between users,

Wherein, steps 1-1, 1-2 and 1-3 are performed in parallel. The second stage comprises the following specific implementation steps:

step 2-1: determining correlations between five classes of correspondence relations according to the classification of the complex correspondence relations completed in step 1-2 and the behavior characteristics of each class;

step 2-2: establishing user extended behavior profile relations according to the behavior profile relations refined in step 1-1;

step 2-3: converting user behavior relations into matrix elements based on step 2-2 in combination with step 1-3 according to a formula

$${a}_{ij} = \{ \begin{matrix}2 & \text{?} + {a}_{j} \\ 1 & \text{?} {a}_{j} \text{?} {a}_{j} \\ {0}_{0} & \text{?} {a}_{j} \\ {0}_{1} & \text{?} {a}_{j} \\ {0}_{2} & \text{?} {a}_{j} \\ {0}_{3} & \text{?} \\ 1 & \text{?}\end{matrix} ( i , j = 1 , 2 , … , n ) \\ \text{?} \text{indicates text missing or illegible when filed}$$

(wherein aᵢⱼ denotes elements in behavior relation matrix); and

step 2-4: establishing a user behavior relation matrix graph based on steps 2-2 and 2-3.

wherein, an establishment step thereof is as follow (from matrix MD₁→MD₂→MD₃→MD₄ . . . →MDₙ→MD):

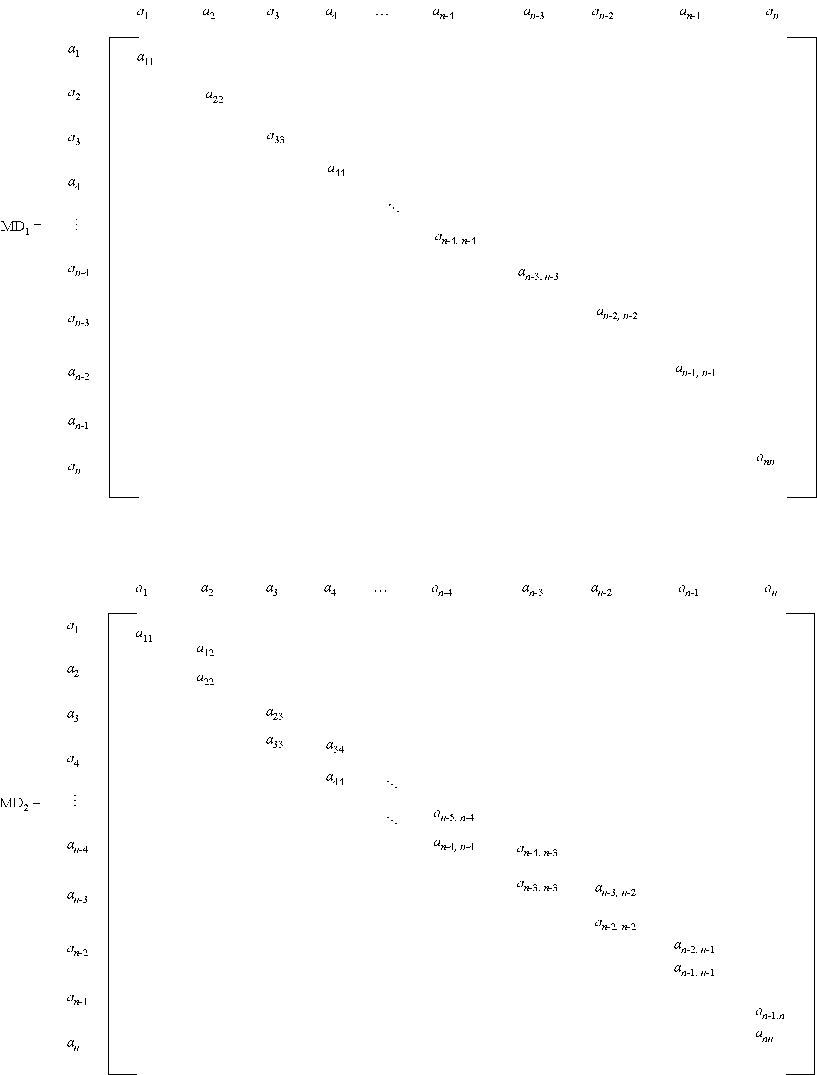

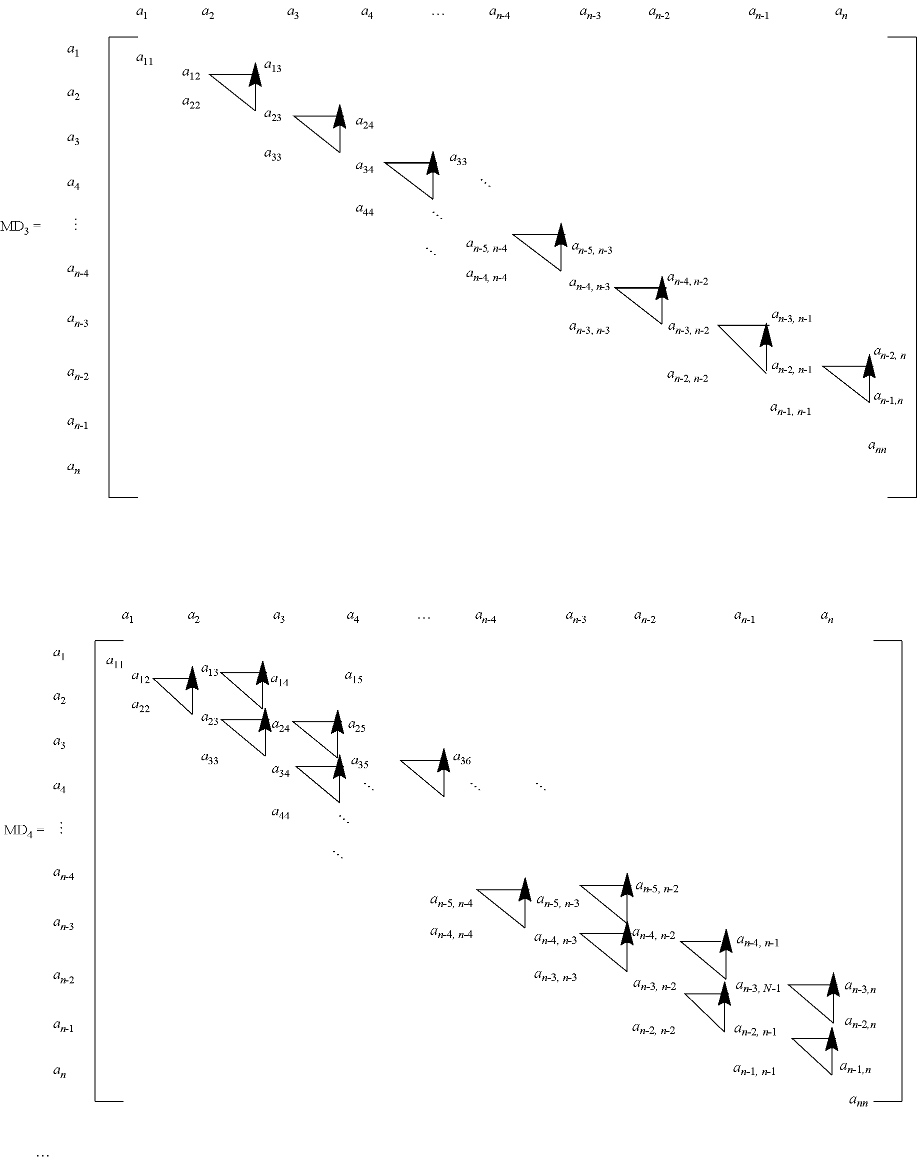

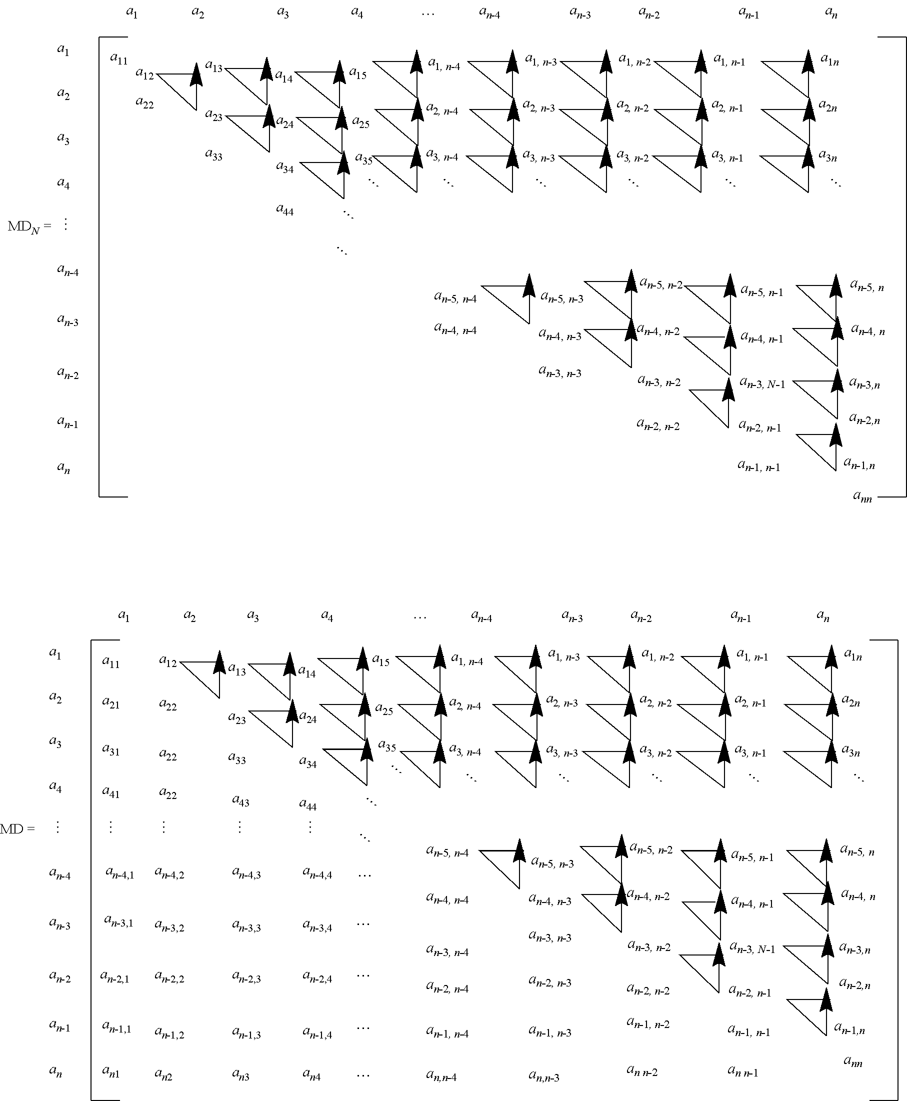

The third stage comprises the following specific implementation steps:

step 3-1: decomposing user behavior relation matrixes according to the five user complex correspondence relation classes determined in step 2-1 and the behavior relation matrix graph established in step 2-4 (for details, see algorithm 1); and step 3-2: calculating behavior consistency between a user model and an expected model according to correspondence relations between an actual model and the expected model of a user (for details, see algorithm 2), calculation formula:

$$consistency degree = \frac{area of consistent behavior relation matrixes}{total area of behavior relation matrixes}$$

wherein consistent behavior relations show consistent portions of user activities, area of behavior matrixes is used by us for depicting entire consistent behavior relations thereof, a higher consistency value represents that user behaviors and expected behaviors are more consistent, a lower consistency value represents that the user behavior and the expected behaviors are more inconsistent, and when consistency is particularly low, the user behaviors are suspected by us as illegal behaviors.

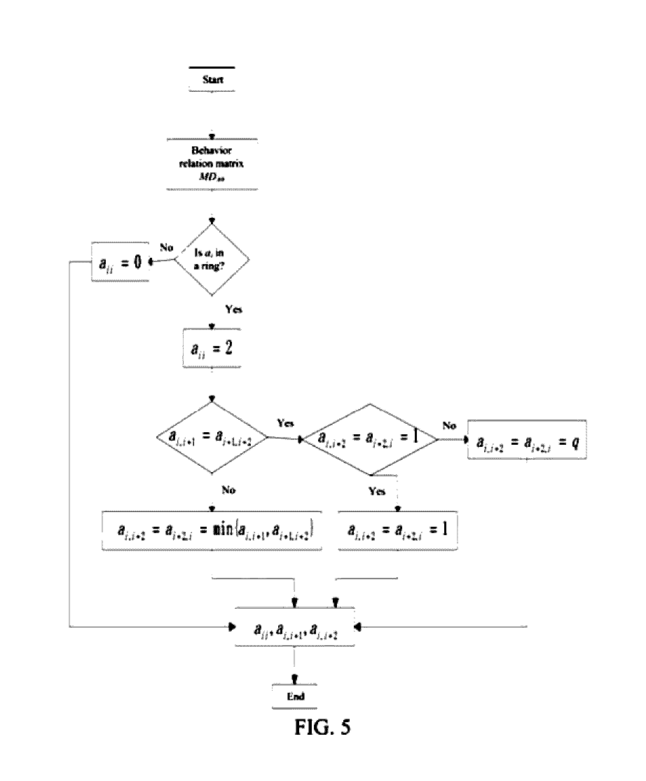

Algorithm 1: a solution algorithm of elements in behavior relation matrix graph (for specific processes, see FIG. 5)

input: two workflow nets N₁−(P₁, T₁; F₁) and N₂−(P2₁, T₂; F₂), wherein they have transition sets of correspondence relations A={a₁, a₂, . . . , aₙ}, B={b₁, b₂, . . . , bₘ}, aᵢⱼ={0|aᵢ [symbol] aⱼ)} [symbol] {1|(aᵢ\tilde{→}aⱼ) [symbol] (aᵢ\tilde{→}⁻¹aⱼ)} [symbol] {2|(aᵢ+aⱼ)} [symbol] {3|aᵢ∥₊aⱼ} (i=1,2, . . . , n), bᵢⱼ={0|bᵢ [symbol] bⱼ} [symbol] {1|(bᵢ\tilde{→}ⱼb) [symbol] (bᵢ\tilde{→}⁻¹bⱼ)} [symbol] {2|(bᵢ+bⱼ)} [symbol] {3|bᵢ∥₊bⱼ} (i=1, 2, . . . , m), behavior matrixes MD_{A0} and MD_{B0} for ordering;

output: elements aᵢⱼ(i,j=1, 2, . . . , n) and bᵢⱼ(i, j=1, 2, . . . , m) in behavior relation matrix graphs MD_{A} and MD_{B};

(1) firstly determining elements aᵢᵢ(i=1, 2, . . . , n) of diagonals in MD_{A}, sequentially judging whether aᵢ(i=1, 2, . . . , n) is in a ring structure or not, and if a, is not in the ring structure, outputting aᵢᵢ=2 and executing step (2); or else, outputting aᵢᵢ=0 and executing step (2);

(2) then determining values of aᵢᵢ₊₁ and a_{i+1,i} (i=1,2, . . . , n−1), in the net N₁, sequentially calculating behavior relations between aᵢ and aᵢ₊₁, then converting the behavior relations into an integer p, outputting a_{i,i+1}=a_{i-1,i}=p, and executing step (3);

(3) then determining values of a_{i,i+2} and a_{i+2,i} (i=1, 2, . . . , n−2); if aᵢᵢ₊₁≠a_{i+1, 1+s}, outputting a_{i,i+2}=a_{i+2,i}=min{a_{i,j+1}, a_{i+1,i+2}}; ort else, if a_{i,i-1}=a_{i+1, i+2}=1, outputting a_{i,i+2}=a_{i+2,i}=1; or else, if a_{i,i+1}=a_{i+1,i-2}≠1, judging behavior relations between aᵢ and aᵢ₊₂ and converting the behavior relations into a relation value q, outputting a_{i,i+2}=a_{i+2,i}=q, and executing step (4);

(4) similarly, determining and a_{i,i+h} and a_{i+h,i} (i=1, 2, . . . , n−h) (h=3, . . . , n−1), outputting a_{i,i+h}=a_{i+h,i}, and ending the algorithm till the last element a₁ₙ.

Similarly, we calculate elements bᵢⱼ (i,j=1, 2, . . . ,m) in MD_{B} according to the algorithm 1 to obtain a matrix MD_{B}.

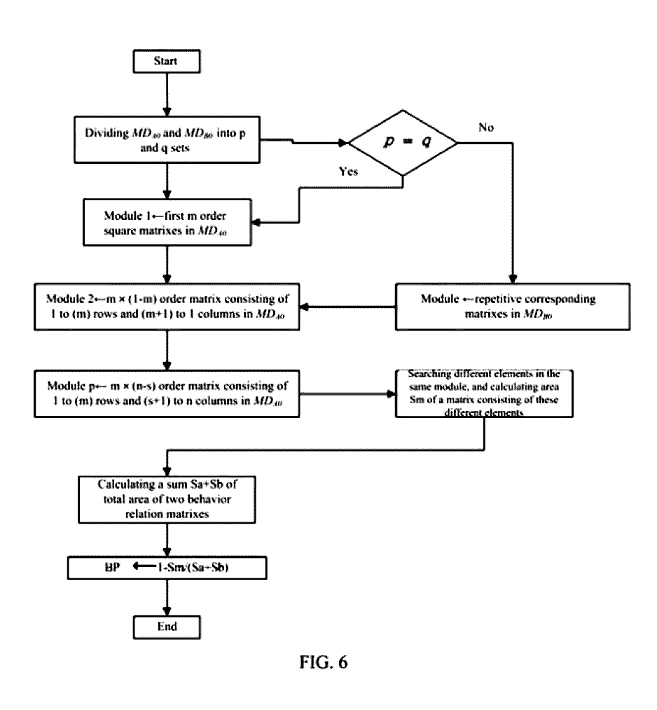

Algorithm 2: a solution algorithm of consistency degree (for specific processes, see FIG. 6)

input: two workflow nets N₁=(P₁, T₁; F₁) and N₂(P2₁,T₂;F₂), wherein relation matrixes MD_{A0} and MD_{B0} thereof are solved through the algorithm 1;

output: consistency degree BP

(1) firstly and respectively dividing MD_{A0} and MD_{B0} into p and q corresponding sets according to correspondence relations of the transition sets in MD_{A0} and MD_{B0}, sequentially marking MD_{A0} as {a₁, a₂, . . . , aₘ},{aₘ₊₁, aₘ₊₂ , . . . , a₁} . . . {aₛ₊₁, . . . , aₙ}, and executing step (2);

(2) firstly taking and marking first m order square matrixes in MD_{A0} as a module 1 according to a first set {a₁, a₂, . . . , aₘ}, corresponding to MD_{B0}, in MD_{A0}, and executing step (3);

(3) taking and marking an m×(1−m) order matrix consisting of 1→(m) rows and (m+1)→(1) columns in MD_{A0} and a transposed matrix thereof as a module 2 according to a second set {aₘ₊₁, aₘ₊₂ , . . . , a₁}, corresponding to MD_{B0}, in MD_{A0}, and executing step (4);

(4) following the previous step till a pth set {aₛ₊₁ , . . . , aₙ}, corresponding to MD_{B0}, in MD_{A0}, taking and marking an m×(n−s) order matrix consisting of 1→(m) rows and (s+1)→(n) columns in MD_{A0} and a transposed matrix thereof as a module p, and executing step (5);

(5) taking and marking an (1−m) order matrix consisting of (m+1)→(1) rows and(m+1)→(1) columns in MD_{A0} as a module p+1 according to a second set {aₘ₊₁, aₘ₊₂, . . . , a₁}, corresponding to MD_{B0}, in MD_{A0}, and executing step (6);

(6) following step (4), marking a (1−m)x(n−s) order matrix consisting of (m+1)→(1) rows and (s+1)→(n) columns in MD_{A0} and a transposed matrix thereof as a module p+2, and executing step (7);

(7) performing operation in this way till a pth set {aₛ₊₁ , . . . , aₙ}, corresponding to MD_{B0}, in MD_{A0}, taking and marking a (n−s) order matrix consisting of s+1→n rows and s+1→n columns as a module

$$\frac{p ( p + 1 )}{2} ,$$

and executing step (8);

(8) if p=q, similarly also decomposing MD_{B0} into

$$\frac{p ( p + 1 )}{2}$$

corresponding modules, marking the modules as module 1, 2, . . .

$$\frac{p ( p + 1 )}{2} ,$$

and executing step (10); or else, if p≠q, also decomposing non-repetitive correspondence relations in MD_{B0} into

$$\frac{p ( p + 1 )}{2}$$

corresponding modules, and executing step (9);

(9) locking repetitive corresponding transition sets, sequentially marking areas consisting of the repetitive corresponding sets as module

$$\frac{p ( p + 1 )}{2} + 1 = 1 , \text{?} \frac{p ( p + 1 )}{2} + 2 = 2 , … , \frac{p ( p + 1 )}{2} + ( q - p ) = {( q - p )}_{n} , \\ \text{?} \text{indicates text missing or illegible when filed}$$

and executing step (10); and

(10) sequentially checking matrix elements in module 1, 2, . . . ,

$$\frac{p ( p + 1 )}{2}$$

in MD_{A0}, finding out aᵢ, aᵢ and different elements bᵢ, bⱼ in the same module of MD_{B0}, if p=q, outputting a consistency degree BP, and ending the algorithm, and if p≠q, locking module 1_{c}, 2_{c}, . . . ,(q−p)_{c}, outputting a consistency degree BP, and ending the algorithm.

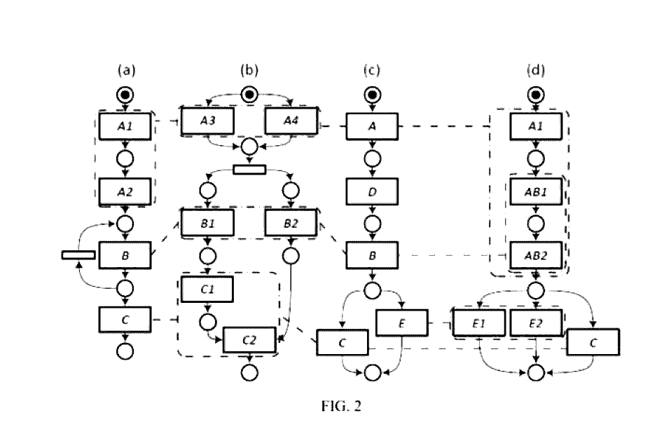

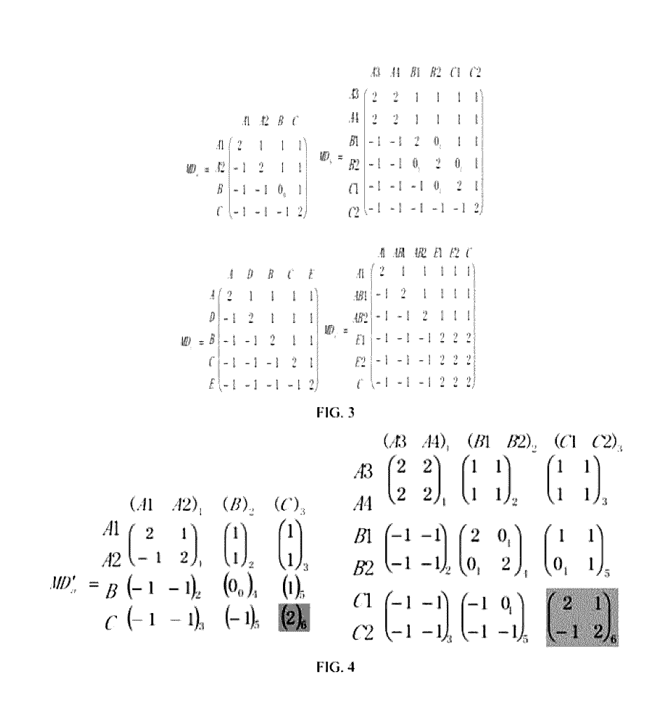

An example of FIG. 2 is given below. According to the algorithm 1, behavior relation matrix graphs MDₐ, MD_{b}, MD_{c}, and MD_{d} in FIGS. 2(a), (b), (c) and (d) (as shown in FIG. 3) are respectively obtained, and then decomposition is respectively performed according to steps (1)-(9) of the algorithm 2, by taking MDₐ and MD_{b} as an example, as shown in FIG. 4. According to step (10) of the algorithm 2, a consistency degree between (a) and (b) in FIG. 2 can be obtained as follow:

$$B \text{?} = 1 - \frac{\text{?} ( \text{?} + \text{?} )}{\text{?} + \text{?}} = 1 - \frac{( 1 \times 2 + 1 \times 1 + 1 \times 1 + 1 \times 1 ) + ( 1 \times 1 + 1 \times 2 + 1 \times 2 + 1 \times 2 )}{4 \times 4 + 6 \times 6} = 1 - \frac{13}{52} = 0.75 ;$$

$$\text{?} \text{indicates text missing or illegible when filed}$$

similarly a consistency degree between (c) and (d) in FIG. 2 can be obtained as follow:

$$1 - \frac{( 1 \times 2 + 1 \times 2 + 1 \times 2 ) + ( 1 \times 1 + 1 \times 1 + 1 \times 1 )}{6 \times 6 + 3 \times 3} = 0.8 ;$$

and in (c) and (d) in FIG. 2, A˜{A1, AB1, AB2}, B˜{AB1. AB2} and thus a profile consistency degree between (c) and (d) in FIG. 2 is as follow:

$$1 - \frac{( 1 \times 1 + 1 \times 1 ) + ( 1 \times 2 + 3 \times 2 )}{6 \times 6 + 3 \times 3} = \frac{42}{52} \approx 0.81 .$$

A consistency degree between a user behavior (a) and a user behavior (b) as shown in FIG. 2 reaches 75%, a consistency degree between a user behavior (b) and a user behavior (c) as shown in FIG. 2 reaches 80%, a consistency degree between a user behavior (c) and a user behavior (d) as shown in FIG. 2 reaches 81% and all consistency degrees are comparatively high, indicating that the user behaviors are consistent with the expected behaviors, such that we judge that the user behaviors are legal behaviors.

Innovative Points of the Invention

1. User behavior mode consistency is quantified by using a behavior profile technology.

2. User complex behavior relations are classified and behavior characteristics and natures of each complex class are determined.

3. A behavior matrix method is put forward, behavior relations between model pairs are converted into elements of behavior relation matrixes and calculation time is shortened.

4. Cross repetitive correspondence situations are distinguished, accuracy is improved and the problem of measurement of behavior consistency between cross repetitive models is solved.

What is claimed is:

1. A method for measuring a user behavior consistency degree based on a complex correspondence system, characterized in that an entire solution is divided into three stages:
a first stage comprising the following specific implementation steps:
step 1-1: subdividing cross order relations based on an existing workflow net, and refining behavior profile relations;
step 1-2: analyzing complex correspondence relations, classifying the complex correspondence relations and determining behavior characteristics of each class; and
step 1-3: simultaneously analyzing transitive dependency relations between user activities according to indirect relations between users;
wherein the steps 1-1, 1-2 and 1-3 are performed in parallel;
a second stage comprising the following specific implementation steps:
step 2-1: determining correlations between five classes of correspondence relations according to the classification of the complex correspondence relations completed in step 1-2 and the behavior characteristics of each class;
step 2-2: establishing user extended behavior profile relations according to the behavior profile relations refined in step 1-1;
step 2-3: converting user behavior relations into matrix elements based on the step 2-2 in combination with the step 1-3 according to a formula
$${a}_{ij} = \{ \begin{matrix}2 & \text{?} + {a}_{j} \\ 1 & \text{?} {a}_{j} \\ {0}_{0} & \text{?} {a}_{j} \\ {0}_{1} & \text{?} {a}_{j} \\ {0}_{2} & \text{?} {a}_{j} \\ {0}_{3} & \text{?} {a}_{j} \\ - 1 & \text{?} {a}_{j}\end{matrix} ( i , j = 1 , 2 , … , n ) \\ \text{?} \text{indicates text missing or illegible when filed}$$
(wherein aᵢⱼ denotes elements in behavior relation matrix); and
step 2-4: establishing a user behavior relation matrix graph based on the steps 2-2 and 2-3,
wherein an establishment step thereof is as follow (from matrix MD₁→MD₂→MD₃→MD₄ . . . →MDₙ→MD): 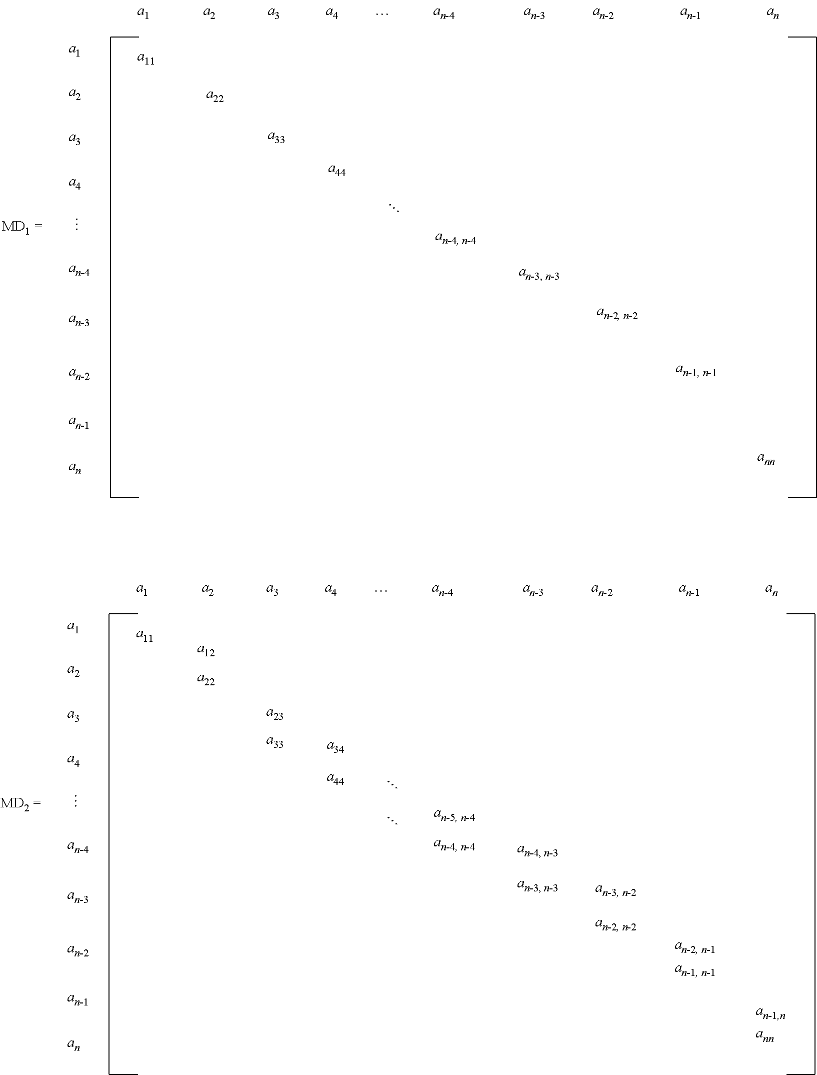 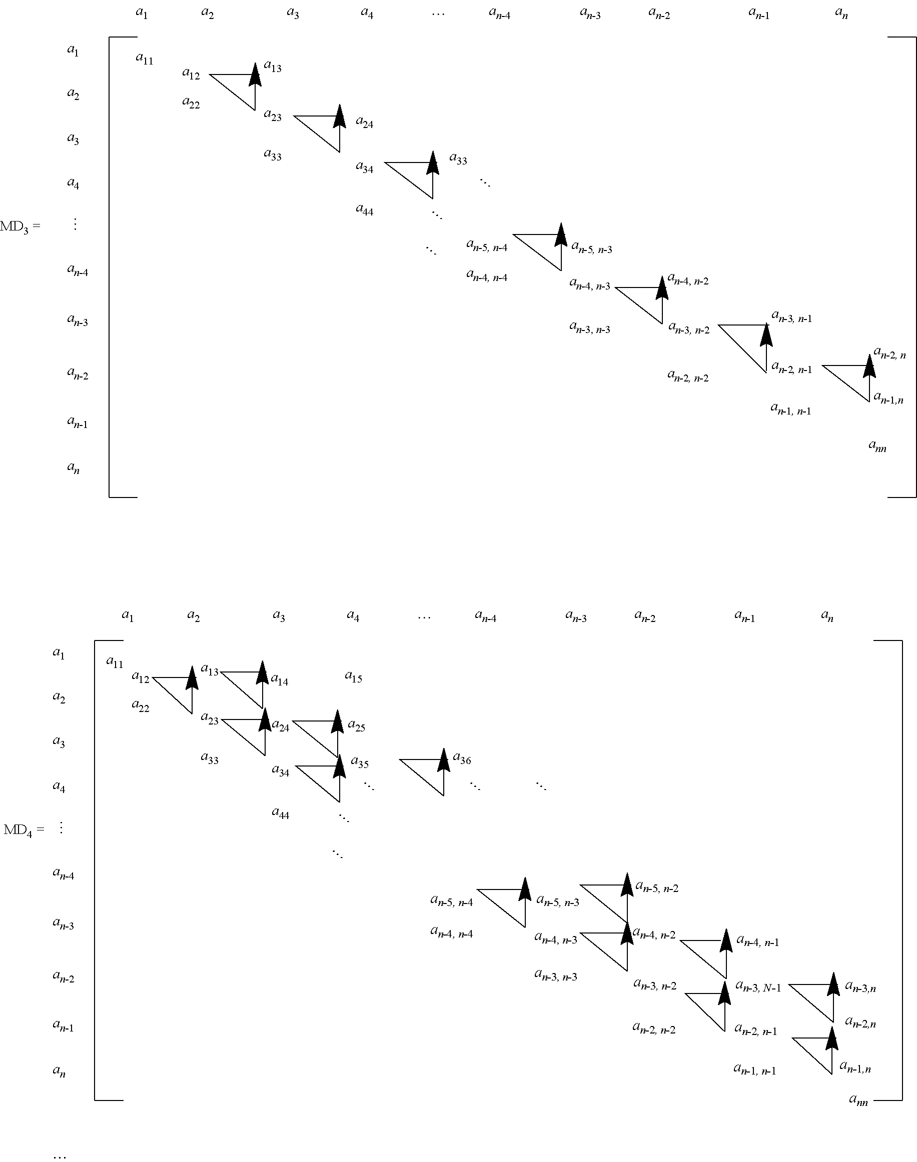 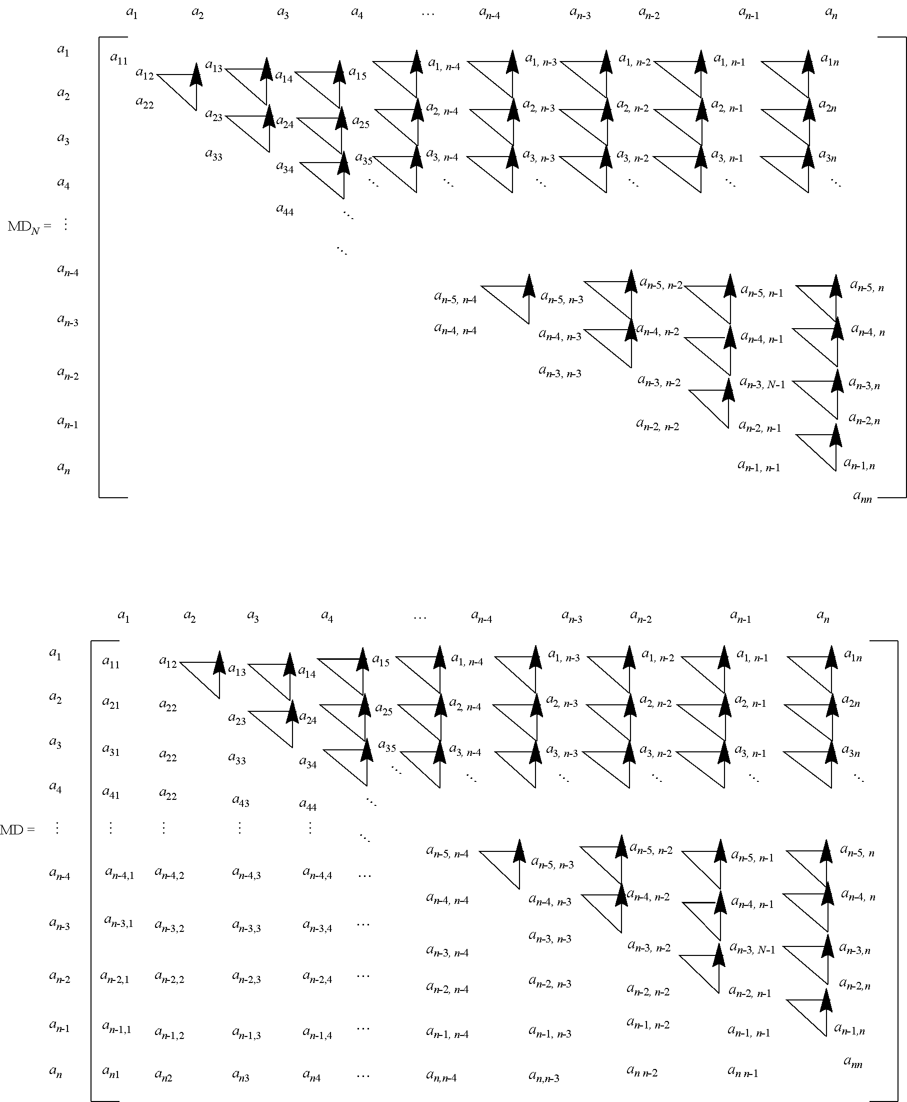
a third stage comprising the following specific implementation steps:
step 3-1: decomposing user behavior relation matrixes according to the five user complex correspondence relation classes determined in the step 2-1 and the behavior relation matrix graph established in the step 2-4; and
step 3-2: calculating behavior consistency between a user model and an expected model according to correspondence relations between an actual model and the expected model of a user,
calculation formula:
$$consistency degree = \frac{area of consistent behavior relation matrixes}{total area of behavior relation matrixes}$$
wherein consistent behavior relations show consistent portions of user activities, area of behavior matrixes is used for depicting entire consistent behavior relations thereof, a higher consistency value represents that user behaviors and expected behaviors are more consistent, a lower consistency value represents that the user behavior and the expected behaviors are more inconsistent, and when consistency is particularly low, the user behaviors are suspected as illegal behaviors.

2. The method for measuring a user behavior consistency degree based on a complex correspondence system according to claim 1, characterized in that, in the step 3-1 of decomposing the user behavior relation matrixes, a solution algorithm of elements in the behavior relation matrix graph thereof is as follow:
input: two workflow nets N₁(P₁,T₁;F₁) and N₂(P2₁,T₂; F₂), wherein they have transition sets of correspondence relations A={a₁, a₂, . . . , aₙ}, B={b₁, b₂, . . . , bₘ}, aᵢⱼ={0|aᵢ [symbol] aⱼ)} [symbol] {1|(aᵢ\tilde{→}aⱼ) [symbol] (aᵢ\tilde{→}⁻¹aⱼ)} [symbol] {2|aᵢ+aⱼ)} [symbol] {3|aᵢ∥₊aⱼ} (i=1, 2, . . . , n), bᵢⱼ={0|bᵢ [symbol] bⱼ) [symbol] {1|(bᵢ\tilde{→}ⱼb)} [symbol] (bᵢ\tilde{→}⁻¹bⱼ)} [symbol] {2|(bᵢ+bⱼ)} [symbol] {3|bᵢ∥₊bⱼ} (i=1, 2, . . . , m), behavior matrixes MD_{A0} and MD_{B0} for ordering;
output: elements aᵢⱼ (i, j=1, 2, . . . , n) and bᵢⱼ (i, j=1, 2, . . . , m) in behavior relation matrix graphs MD_{A} and MD_{B};
(1) firstly determining elements aᵢᵢ (i=1, 2, . . . , n) of diagonals in MD_{A}, sequentially judging whether aᵢ (i=1, 2, . . . , n) is in a ring structure or not, and if aᵢ is not in the ring structure, outputting aᵢᵢ=2 and executing step (2); or else, outputting aᵢᵢ=0 and executing step (2);
(2) then determining values of a_{i,i+1} and a_{i+1,i}(i=1, 2, . . . , n−1), in the net N₁, sequentially calculating behavior relations between aᵢ and aᵢ₊₁, then converting the behavior relations into an integer p, outputting a_{i,i+1}=a_{i+1,i}=p, and executing step (3);
(3) then determining values of a_{i,i+2} and a_{i+2,i} (i=1, 2, . . . , n−2); if a_{i,i+1}≠a_{i+1,i+2}, outputting a_{i,i+2}=a_{i+2,i}=min{a_{i,j+1}, a_{i+1,i+2}}; or else, if a_{i,i+1}=a_{i+1.1+2}=1, outputting a_{i,i+2}=a_{i+2,i}=1; or else, if a_{i,i+1}=a_{i+1,i+2}≠1, judging behavior relations between aᵢ and aᵢ₊₂ and converting the behavior relations into a relation value q, outputting a_{i,i+2}=a_{i+2,i}=q, and executing step (4);
(4) similarly, determining a_{i,i+h} and a_{i+h,1} (i=1, 2, . . . , n−h) (h=3, . . . , n−1), outputting a_{i,i+h}=a_{i+h,i}, and ending the algorithm till the last element a₁ₙ;
similarly, calculating elements bᵢⱼ (i, j=1, 2, . . . , m) in MD_{B} according to the solution algorithm of the elements in the behavior relation matrix graph to obtain a matrix MD_{B}.

3. The method for measuring a user behavior consistency degree based on a complex correspondence system according to claim 1, characterized in that, in the step 3-2 of calculating the behavior consistency between the user model and the expected model, a solution algorithm of a consistency degree thereof is as follow:
input: two workflow nets N₁=(P₁, T₁; F₁) and N₂ (P2₁, T₂; F₂), wherein relation matrixes MD_{A0} and MD_{B0} thereof are solved through the solution algorithm of the elements in the behavior relation matrix graph in the step 3-1;
output: a consistency degree BP
(1) firstly and respectively dividing MD_{A0} and MD_{B0} into p and q corresponding sets according to correspondence relations of transition sets in MD_{A0} and MD_{B0}, sequentially marking MD_{A0} as {a₁, a₂, . . . , aₘ}, {aₘ₊₁, aₘ₊₂, . . . , a₁} . . . {aₛ₊₁, . . . , aₙ}, and executing step (2);
(2) firstly taking and marking first m order square matrixes in MD_{A0} as a module 1 according to a first set {a₁, a₂, . . . aₘ}, corresponding to MD_{B0}, in MD_{A0}, and executing step (3);
(3) taking and marking an m×(1−m) order matrix consisting of 1→(m) rows and (m+1)→(1) columns in MD_{A0} and a transposed matrix thereof as a module 2 according to a second set {aₘ₊₁, aₘ₊₂, . . . , a₁}, corresponding to MD_{B0}, in MD_{A0}, and executing step (4);
(4) following the previous step till a pth set {aₛ₊₁ , . . . , aₙ}, corresponding to MD_{B0}, in MD_{A0}, taking and marking an m×(n−s) order matrix consisting of 1→(m) rows and (s+1)→(n) columns in MD_{A0} and a transposed matrix thereof as a module p, and executing step (5);
(5) taking and marking a (1−m) order matrix consisting of (m+1)→(1) rows and (m+1)→(1) columns in MD_{A0} and a transposed matrix thereof as a module p+1 according to a second set {aₘ₊₁, aₘ₊₂ , . . . , a₁}, corresponding to MD_{B0}, in MD_{A0}, and executing step (6);
(6) following step (4), marking a (1−m)×(n−s) order matrix consisting of (m+1)→(1) rows and (s+1)→(n) columns in MD_{A0} and a transposed matrix thereof as a module p+2, and executing step (7);
(7) performing operation in this way till a pth set {aₛ₊₁ , . . . , aₙ}, corresponding to MD_{B0}, in MD_{A0}, taking and marking a (n−s) order matrix consisting of s+1→n rows and s+1→n columns as a module
$$\frac{p ( p + 1 )}{2} ,$$
and executing step (8);
(8) if p=q, similarly also decomposing MD_{B0} into
$$\frac{p ( p + 1 )}{2}$$
corresponding modules, marking the modules as module 1, 2, . . .
$$\frac{p ( p + 1 )}{2} ,$$
and executing step (10); or else, if p≠q, also decomposing non-repetitive correspondence relations in MD_{B0} into
$$\frac{p ( p + 1 )}{2}$$
corresponding modules, and executing step (9);
(9) locking repetitive corresponding transition sets, sequentially marking areas consisting of the repetitive corresponding sets as module
$$\frac{p ( p + 1 )}{2} + 1 = 1 , \text{?} \frac{p ( p + 1 )}{2} + 2 = 2 , … , \frac{p ( p + 1 )}{2} + ( q - p ) = ( q - p ) \text{?} , \\ \text{?} \text{indicates text missing or illegible when filed}$$
and executing step (10); and
(10) sequentially checking matrix elements in module 1, 2,. . . ,
$$\frac{p ( p + 1 )}{2}$$
in MD_{A0}, finding out aᵢ, aᵢ and different elements bᵢ, bⱼ in the same module of MD_{B0}, if p=q, outputting a consistency degree BP, and ending the algorithm, and if p≠q, locking module 1_{c}, 2_{c}, . . . , (q−p)_{c}, outputting a consistency degree BP, and ending the algorithm.
